(19) United States
(12) Patent Application Publication
(10) Pub. No.: US 2024/0404041 A1
(43) Pub. Date: Dec. 5, 2024

(54) SYSTEMS AND METHODS FOR ONBOARD AUTO-INSPECTION OF VEHICLES USING REFLECTIVE SURFACES

(71) Applicant: UVeye Ltd., Tel Aviv (IL)

(72) Inventors: Amir HEVER, Tenafly, NJ (US); Ilya BOGOMOLNY, ModiIn (IL)

(73) Assignee: UVeye Ltd., Tel Aviv (IL)

(21) Appl. No.: 18/679,568

(22) Filed: May 31, 2024

Related U.S. Application Data
(60) Provisional application No. 63/505,572, filed on Jun. 1, 2023.

(51) Int. Cl. G06T 7/00; G01C 21/36; G06T 7/12; G06T 7/70; G06V 10/77

(52) U.S. Cl. CPC G06T 7/001; G01C 21/3602; G06T 7/12; G06T 7/70; G06V 10/7715; G06T 2207/20084; G06T 2207/30136; G06T 2207/30204; G06T 2207/30252

(57) ABSTRACT

Systems and methods for onboard auto-inspection of vehicles using reflective surfaces. The system comprises at least one imaging device mounted on the vehicle, capturing reflections of the vehicle's exterior from strategically positioned reflective surfaces. The captured imaging data is processed by one or more processing circuitries to detect and analyse defects or anomalies on the vehicle's exterior surface. The invention also describes a support system consisting of a scaffold with mounted reflective surfaces, easily integrable into existing infrastructure. The system employs advanced image analysis techniques to accurately detect and localize defects, generating a detailed defect map. The invention further encompasses a complete kit, including the onboard auto-inspection system and the support system, providing a comprehensive solution for vehicle inspection and maintenance. By enabling efficient, accurate, and frequent inspections, the present invention promotes safer, better-maintained vehicles and advances the field of automotive inspection technology.

### RELATED APPLICATION

This application claims the benefit of priority under 35 USC § 119 (e) of U.S. Provisional Patent Application No. 63/505,572 filed on Jun. 1, 2023, the contents of which are incorporated by reference as if fully set forth herein in their entirety.

### FIELD AND BACKGROUND OF THE INVENTION

The present invention, in some embodiments thereof, relates to systems and methods for inspection of vehicles and, more particularly, but not exclusively, to systems and methods for auto inspection of vehicles.

Inspecting vehicles for defects is an important part of maintaining vehicle safety and performance. Traditionally, vehicle inspection has been performed manually by trained technicians who visually examine the vehicle's exterior and interior surfaces for signs of damage, wear, or other issues. However, manual inspection is time-consuming, labor-intensive, and prone to human error.

In recent years, various automated vehicle inspection systems have been developed to improve the efficiency and accuracy of the inspection process. These systems often use cameras, sensors, and computer vision algorithms to detect and analyze defects on the vehicle's surface. However, most of these systems require the vehicle to be positioned in a specific way relative to the inspection equipment, which can be difficult to achieve consistently.

Moreover, as vehicles become increasingly complex and automated, there is a growing need for onboard inspection systems that can be integrated directly into the vehicle itself. Such systems could allow vehicles to perform self-inspections regularly and autonomously, without the need for external equipment or human intervention.

### SUMMARY OF THE INVENTION

The present invention relates to systems and methods for onboard auto-inspection of vehicles using reflective surfaces. The invention addresses the need for efficient, accurate, and comprehensive inspection of vehicle exteriors by leveraging the vehicle's onboard imaging devices and strategically positioned reflective surfaces. The system comprises at least one imaging device mounted on or in the vehicle, which captures reflections of the vehicle's exterior from a plurality of reflective surfaces positioned around the vehicle. The captured imaging data is processed by one or more processors to detect and analysed defects, damage, or anomalies on the vehicle's exterior surface.

The invention offers several advantages over traditional inspection methods, such as reduced complexity, improved accuracy, and increased flexibility. By utilizing the vehicle's onboard imaging devices and processing capabilities, the system eliminates the need for external inspection equipment and enables frequent, automated inspections.

The reflective surfaces are positioned based on various system parameters to ensure optimal coverage and image quality. The system also incorporates additional features, such as machine-readable markings, localization devices, and communication capabilities, to enhance the efficiency and usability of the inspection process.

The processing circuitry employs advanced image analysis techniques, including edge detection, template matching, machine learning, and sensor fusion, to accurately detect and localize defects within the vehicle's exterior contour. The system generates a detailed defect map, which may be used to guide maintenance decisions and ensure timely repairs.

Some embodiments of the present invention also describe a support system for the onboard auto-inspection, consisting of a scaffold with mounted reflective surfaces. The support system may be easily integrated into existing infrastructure, such as parking spaces or garages, and may be adapted to accommodate different vehicle types and models.

Overall, the present invention provides a comprehensive, efficient, and cost-effective solution for onboard auto-inspection of vehicles, improving vehicle safety, maintenance, and overall operational efficiency. The system has wide-ranging applications, from personal vehicles to commercial fleets, and represents a significant advancement in the field of vehicle inspection and maintenance technology.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 illustrates an exemplary vehicle with a vehicle system for providing one or more onboard auto-inspection capabilities to a vehicle and a blowup depicting components of the vehicle system (100), according to some embodiments of the present invention;

FIG. 2 illustrates a flowchart depicting a method that uses the system described in FIG. 1 for executing onboard auto-inspection of a vehicle in which the system described in FIG. 1 with reflective surfaces, according to some embodiments of the present invention;

FIG. 3 which is a schematic illustration of a support system for supporting auto inspection of vehicles using onboard system such as described in FIG. 1, according to some embodiments of the present invention; and

FIGS. 4A and 4B depict light reflected from portions of the vehicle are reflected using one or more reflective surfaces mounted, according to some embodiments of the present invention, towards an image device.

### DESCRIPTION OF SPECIFIC EMBODIMENTS OF THE INVENTION

The present invention, in some embodiments thereof, relates to systems and methods for inspection of vehicles and, more particularly, but not exclusively, to systems and methods for auto inspection of vehicles.

Challenges in developing onboard inspection systems are providing adequate illumination and viewing angles for the vehicle's imaging devices to capture clear and comprehensive images of the vehicle's surface. Mounting cameras or other sensors at various locations on the vehicle can provide some coverage, but there may be areas that are difficult or impossible to image directly.

To address these limitations, the embodiments of the present invention provide systems and methods for onboard auto-inspection of vehicles using reflective surfaces. By mounting a set of reflective surfaces along an inspection area, vehicle's onboard imaging devices can capture reflected light from various angles, allowing for more complete and detailed imaging of the vehicle's surface. The reflective surfaces may be positioned and configured based on the specific layout and imaging capabilities of each vehicle, ensuring optimal inspection performance.

Furthermore, the embodiments of the present invention describe additional features to enhance the functionality and usability of the onboard inspection system, such as machine-readable codes for triggering the inspection process, localizing devices for determining the vehicle's position relative to the reflective surfaces, and processing circuitry for analyzing the captured images and providing alignment guidance.

By enabling vehicles to perform comprehensive self-inspections using onboard imaging devices and strategically positioned reflective surfaces, the present invention has the potential to greatly improve the efficiency, reliability, and cost-effectiveness of vehicle inspection. This could ultimately lead to safer, better-maintained vehicles and reduced inspection burdens on human technicians.

The embodiments described herein offer benefits and advantages in the field of vehicle inspection and maintenance. The onboard auto-inspection system revolutionizes the way vehicles are inspected, providing a convenient, efficient, and cost-effective solution for detecting and monitoring defects on a vehicle's surface.

One of the benefits of the onboard auto-inspection system is its ability to perform comprehensive and accurate inspections without the need for manual intervention or inspection units which are external to the vehicle. By leveraging advanced imaging technologies, such as cameras, the vehicle system (100) can capture detailed and reliable data of the vehicle's exterior based on analysis of reflections from reflective surfaces only. This eliminates the subjectivity and potential for human error associated with traditional manual inspections, ensuring consistent and thorough defect detection and/or the need in external hardware (apart of the reflective surfaces).

Moreover, the integration of powerful processors (130) and intelligent algorithms enables the system to analyze the captured reflections in real-time, identifying and localizing defects with high precision without the need of external cameras. The use of machine learning and computer vision techniques allows the system to adapt and improve its defect detection capabilities over time, learning from past inspections and continuously refining its performance for a specific vehicle. This level of automation and intelligence significantly reduces the time and effort required for vehicle inspections, while enhancing the overall accuracy and reliability of the results.

Also, the use of reflective surfaces by the onboard auto-inspection system offers several significant advantages over traditional inspection systems where the inspection hardware is external to the vehicle. By leveraging reflective surfaces, the system achieves a more efficient, flexible, and cost-effective approach to vehicle inspection, while maintaining high accuracy and reliability.

One of the benefits of using reflective surfaces is the reduced complexity and infrastructure requirements compared to external inspection hardware. In traditional systems, the inspection equipment, such as cameras, sensors, and lighting units, needs to be permanently installed and calibrated at specific locations around the vehicle. This often requires significant modifications to the inspection facility, including the installation of mounting brackets, power supplies, and data communication lines. In contrast, the reflective surface approach allows for a more streamlined and adaptable setup, as the surfaces may be easily positioned and adjusted around the vehicle without the need for extensive infrastructure changes.

Moreover, the use of reflective surfaces enables a more compact and space-efficient inspection system. External inspection hardware often requires dedicated space and clearance around the vehicle to ensure proper functioning and avoid interference with other equipment. This may be particularly challenging in space-constrained environments, such as small garages or crowded maintenance facilities. By utilizing reflective surfaces, the onboard auto-inspection system can capture comprehensive views of the vehicle's exterior while minimizing the physical footprint of the inspection setup. The surfaces may be strategically placed to maximize coverage and optimize the use of available space, making the system suitable for a wide range of installation environments.

Another key advantage of the reflective surface approach is the enhanced flexibility and adaptability of the inspection process. With external inspection hardware, the vehicle needs to be precisely positioned and aligned with respect to the fixed sensors and cameras to ensure accurate and consistent data capture. Any deviations in the vehicle's position or orientation can lead to misalignments and reduced inspection quality. In contrast, the use of reflective surfaces allows for a more flexible and forgiving inspection setup. The vehicle's onboard imaging devices can capture high-quality reflections from various angles and distances, compensating for minor variations in the vehicle's position. This flexibility reduces the need for precise positioning and alignment, simplifying the inspection process and making it more user-friendly.

Furthermore, the reflective surface approach offers significant cost savings compared to external inspection hardware. The installation and maintenance of dedicated inspection equipment may be expensive, requiring specialized labor, regular calibration, and ongoing support. In addition, the fixed nature of external hardware limits its scalability and adaptability to different vehicle types and inspection requirements. By utilizing the vehicle's onboard imaging devices and processing capabilities, the reflective surface system eliminates the need for costly external hardware and reduces the overall investment required for vehicle inspection. The surfaces themselves may be manufactured from affordable and durable materials, such as polished metal or reflective coatings, further reducing the cost of implementation.

The use of reflective surfaces also enhances the portability and mobility of the inspection system. Unlike fixed external hardware, the reflective surfaces may be easily moved and reconfigured to accommodate different inspection scenarios and vehicle types. This portability is particularly valuable for mobile inspection services or situations where the vehicle needs to be inspected at different locations. The surfaces may be quickly set up and adjusted to provide optimal coverage and imaging quality, enabling efficient and reliable inspections in various settings.

The reflective surface approach promotes a more seamless and integrated inspection process. By relying on the vehicle's onboard imaging devices and processing capabilities, the system can capture and analyze data in real-time, without the need for complex data transfer and synchronization between external hardware and the vehicle. This integration streamlines the inspection workflow, reduces latency, and enables faster and more actionable results. The onboard processors can immediately process the captured imaging data, identifying defects and generating comprehensive inspection reports, allowing for quick decision-making and maintenance planning.

Furthermore, the onboard auto-inspection system promotes enhanced safety and compliance. By providing comprehensive and objective assessments of a vehicle's condition, the system helps ensure that vehicles meet the necessary safety standards and regulations more frequently, for instance every day or week or month. This is particularly important for commercial fleets, where maintaining vehicle safety is critical for both the well-being of drivers and the reputation of the business. The system's automated defect detection and reporting capabilities streamline the process of identifying and addressing safety issues, enabling fleet managers to make informed decisions and take prompt corrective actions.

The onboard auto-inspection system contributes to the overall efficiency and productivity of vehicle maintenance operations. By automating the inspection process and providing detailed defect reports, the system allows maintenance teams to prioritize and schedule repairs more effectively. This optimized workflow reduces vehicle downtime, improves resource allocation, and enhances the overall service quality. The system's ability to store and analyze historical inspection data further enables predictive maintenance strategies, allowing for proactive scheduling of repairs and replacements based on anticipated wear and tear.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

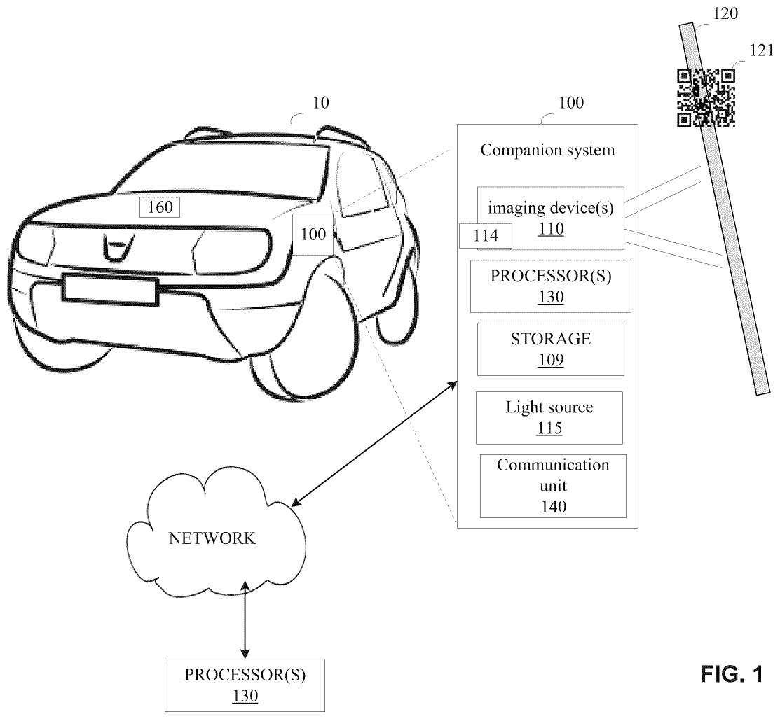

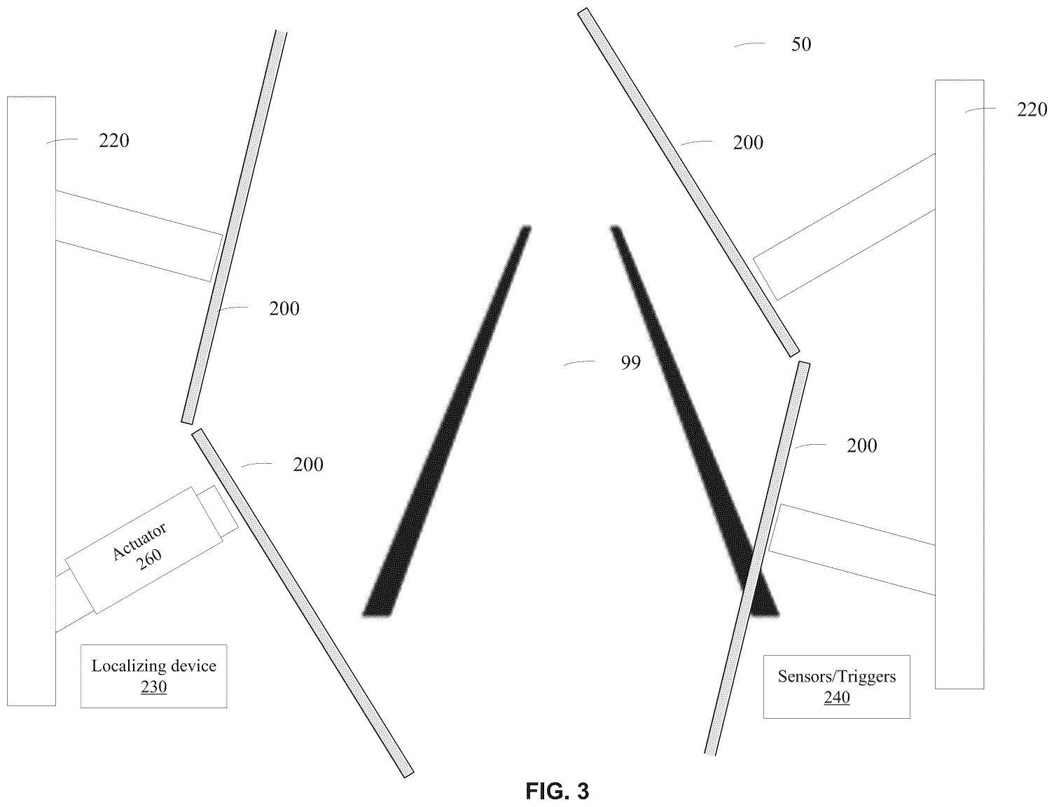

Referring now to the drawings, FIG. 1 illustrates an exemplary vehicle (1) with a vehicle system (100) for providing one or more onboard auto-inspection capabilities to a vehicle and a blowup depicting components of the vehicle system (100). The system comprises one or more imaging devices (110) mounted on or in the vehicle for capturing reflections from one or more of a plurality of reflective surfaces (120) positioned on at least one side of the vehicle. The imaging device (110) generates imaging data portraying at least part of the vehicle from the captured reflections. The reflective surfaces (120) maybe part of mounted to reflect light towards an inspection area. See more with reference to numeral 99 in FIG. 3. The system also includes one or more processors (130) configured to receive the imaging data from the one or more imaging devices (110). The one or more processors (130) analyze the imaging data to detect one or more features of one or more defects within an exterior surface of the vehicle. The term ‘exterior surface’ as used herein refers to the outer surface or contour of the vehicle (100) that is exposed to the environment and visible to the one or more imaging devices (110). The exterior surface encompasses the entire external shell of the vehicle, including but not limited to the body panels, doors, hood, trunk, bumpers, roof, and any other external components. The exterior surface is the primary area of interest for the onboard auto-inspection system, as it is the region where defects, damage, or anomalies may be present and detectable by the imaging devices and processing circuitry. The contour of the exterior surface is a continuous, uninterrupted boundary that defines the shape and extent of the vehicle's outer surface. In the context of this invention, the exterior surface is captured in the imaging data generated by the one or more imaging devices (110) as reflections from the plurality of reflective surfaces (120) positioned around the vehicle.

After analyzing the imaging data, the one or more processors (130) output data indicative of the one or more features of the one or more defects. The one or more processors (130) may execute a code stored on a storage 109, either locally or remotely as described herein below. The one or more processors (130) maybe implemented using various hardware components, depending on the specific requirements of the system, such as processing speed, power consumption, scalability, and cost. For example, the one or more processors (130) are central processing units (CPUs), graphics processing units (GPUs), field-Programmable gate arrays (FPGAs), application-specific integrated circuits (ASICs), System-on-Chip (SoC) solutions and/or any combination thereof.

The one or more features detected by the one or more processors (130) may include spatial position data mapping the one or more defects in a model of the vehicle. This model of the vehicle may be reconstructed from a sequence of images captured by the imaging device (110).

The one or more processors (130) perform the analysis based on one or more system parameters, such as a distance between the one or more imaging devices (110) and one or more of the plurality of reflective surfaces (120), a distance between the vehicle (100) and one or more of the plurality of reflective surfaces (120), an angle between a portion of the vehicle having the one or more defects and the one or more imaging devices (110), a resolution of the at least one image, a field of view of the at least one image, and a focus parameter of the at least one image.

The imaging device(s) (110) maybe digital camera(s). These cameras may be equipped with advanced features such as autofocus, optical zoom, and adjustable aperture and shutter speed to adapt to different lighting conditions. Digital cameras used in the vehicle system (100) can range from compact, mobile-device-grade cameras to professional-grade digital single-lens reflex (DSLR) cameras, depending on the desired image quality and performance. Additionally or alternatively, an infrared camera is used. Infrared cameras detect heat radiation from objects and may be used to identify defects or anomalies that may not be visible in the normal visible light spectrum. These cameras are particularly useful for detecting subsurface defects, such as delamination or moisture intrusion, which can affect the vehicle's structural integrity. Additionally or alternatively, a Time-of-Flight (ToF) camera is used. ToF cameras measure the distance between the camera and objects in the scene by calculating the time it takes for light to travel from the camera to the object and back. These cameras can create detailed 3D maps of the vehicle's exterior, enabling the detection of dents, bumps, or other surface irregularities. Additionally or alternatively, a stereoscopic camera setup is used. The stereoscopic camera setups consist of two or more cameras that capture images of the same scene from slightly different angles. By analyzing the differences between the images, the system can calculate the depth and 3D structure of the vehicle's exterior, facilitating the identification of defects and the creation of 3D models. Additionally, or alternatively omnidirectional camera is used. Omnidirectional cameras, also known as 360-degree cameras, capture images from all directions simultaneously. These cameras may be used to create comprehensive, panoramic views of the vehicle's exterior from the reflections, reducing the need for multiple imaging devices and simplifying the inspection process.

The imaging device(s) (110) maybe integrated digital camera(s) of the vehicle itself. For example, a parking camera of a vehicle or an image sensor used for autonomous or semi-autonomous driving, which are not typically used for inspection, are used for inspection with the system described herein. In such cases, it is necessary to initiate or trigger a scanning process, which means that data will be collected and processed in correlation with a triggering event. Other exemplary digital camera(s) which may be used are a backup camera (rear-view camera), a front camera (forward-facing camera), a side camera (e.g. mirror-mounted camera), a surround-view camera (e.g. 360-degree camera), a pillar-mounted camera integrated into the vehicle's A-pillars (the vertical supports on either side of the windshield) or B-pillars (the vertical supports between the front and rear doors), and/or a rooftop camera mounted on the roof of the vehicle, often used for panoramic viewing or as part of a surround-view system and/or a tailgate camera or a trunk-mounted camera integrated into the tailgate or trunk lid of the vehicle, often used for rear-view display or as part of a surround-view system.

It is important to note that the vehicle system (100) for onboard auto-inspection may be implemented either as an integrated component of the vehicle or as an aftermarket addon. When integrated into the vehicle during the manufacturing process, the system's components, such as the imaging devices (110), one or more processors (130), and light sources (115), are seamlessly incorporated into the vehicle's design and architecture. This integration allows for optimal placement and configuration of the components, ensuring maximum compatibility and performance. Alternatively, the vehicle system (100) is designed as an addon kit that may be retrofitted to existing vehicles. In this case, the components are packaged as a modular unit that may be easily installed on the vehicle, with minimal modifications to the vehicle's structure. The addon approach enables vehicle owners to upgrade their vehicles with the onboard auto-inspection capability, regardless of the make, model, or year of the vehicle. This flexibility makes the vehicle system (100) accessible to a wider range of users and vehicles, promoting the adoption of advanced self-inspection technologies in the automotive industry.

It is important to note that while the one or more processors (130) may be integrated directly into the vehicle system (100), it is also possible for some or all of the one or more processors to be connected to the system via a network. This networked configuration allows for the distribution of processing tasks across multiple devices and locations, providing flexibility and scalability to the system. For instance, the vehicle system (100) may include a transmitter for transmitting the captured imaging data over a network to a remote server, such as a cloud computing platform, for instance using existing ADAS infrastructure. The remote server can host powerful one or more processors that run code and optionally machine learning models to analyze the imaging data and detect defects on the vehicle's exterior. This remote, for example cloud-based, processing approach enables the vehicle system (100) to leverage the vast computational resources and always-up-to-date software available on remote servers, without the need for extensive onboard processing hardware. Additionally, the use of remote one or more processors allows for centralized management and updating of the inspection algorithms, ensuring that all connected vehicle systems benefit from the latest improvements and optimizations. The networked architecture also facilitates the aggregation and analysis of inspection data from multiple vehicles, enabling fleet managers or manufacturers to monitor the condition of their vehicles and make data-driven decisions for maintenance and quality control.

Optionally, the one or more imaging devices (110) includes one or more actuators (114) adapted to tilt the one or more imaging devices (110) or a part thereof according to a scanning pattern to capture reflections from different portions of the vehicle.

The actuators maybe motors which maneuver a pivoted support that permits rotation of the imaging device about an axis. The motors are optionally electric motors may be used to rotate, tilt, or pan the imaging devices (110) to achieve optimal viewing angles and coverage. Examples of electric motors suitable for the vehicle system (100) include stepper motors, servo motors and/or Brushless DC motors. The actuators may also be hydraulic actuators, pneumatic actuators, and/or piezoelectric actuators or any other actuators adapted for maneuvering and/or focusing the imaging devices or maintaining a constant distance between the vehicle's surface and the reflective surfaces.

In use, the one or more processors (130) may execute a code for localizing the one or more defects on the exterior according to the imaging data and control the one or more actuators (114) accordingly. The code can also localize at least one of the pluralities of reflective surfaces (120) according to the imaging data and control the one or more actuators (114) accordingly.

One or more of the plurality of reflective surfaces (120) may have a machine-readable marking (121). The one or more processors (130) can identify one of the plurality of reflective surfaces according to the machine-readable marking and perform the analysis according to predefined logic defined for the identified reflective surface.

The machine-readable markings enable automated identification, tracking, and localization of the reflective surfaces (120) or the location of the vehicle (100) in relation to the reflective surfaces. The machine-readable markings maybe barcodes, printed on labels or directly onto the surfaces of the reflective surfaces (120) or the vehicle (100). Examples of barcode suitable for reading by the vehicle system (100) maybe 1D barcodes, such as Code 128, Code 39, or EAN-13 and 2D barcodes such as QR codes or Data Matrix codes. The marking may also be optical character recognition (OCR) markings such as unique identification numbers, serial numbers, or other relevant data that may be identified by image analysis, infrared (IR) markers printed using IR-reflective or IR-absorbing inks on the reflective surfaces (120), or any other marking useful for discreet identification and tracking.

The machine-readable markings maybe radio frequency identification (RFID) tags. Such markings are identified using RFID reader. Tags are small electronic devices that store and transmit data using radio waves. These tags may be attached to the reflective surfaces (120) and may be read by RFID readers from a distance, without the need for a direct line of sight.

The system may further include a communication unit or circuitry (140) adapted to receive an inspection triggering signal from a wireless transmitter, for instance a transmitter located in proximity to the reflective surfaces. The one or more processors (130) may be configured to perform the analysis after receiving the signal.

Optionally, the one or more processors (130) determine the relative spatial location of the vehicle in relation to at least one of the plurality of reflective surfaces (120) and perform the analysis according to the determined relative spatial location. Additionally, the one or more processors (130) may calculate driving instructions for manoeuvring the vehicle according to the relative spatial location and output the driving instructions for presentation to a driver or a controller (160) configured for manoeuvring the vehicle accordingly.

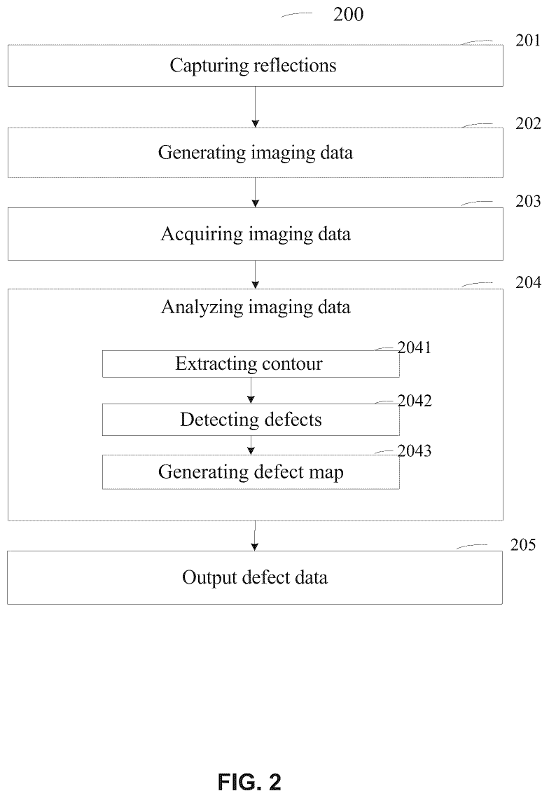

Reference is now also made to FIG. 2 which is a flowchart depicting a method 200 that uses the system described in FIG. 1 for executing onboard auto-inspection of a vehicle in which the system described in FIG. 1 with reflective surfaces, according to some embodiments of the present invention. The method begins with the vehicle (100) being positioned near the plurality of reflective surfaces (120) mounted on at least one side of the vehicle, for instance after instructed to begin by an operator or the driver and/or by a triggering signal such as described above.

First, as shown at 201, reflections of the vehicle's exterior from the reflective surfaces (120) are captured by the one or more imaging devices (110) mounted on or in the vehicle (100) when the imaging device(s) (110) is positioned and oriented to ensure that the reflections cover the desired portions of the vehicle's surface. The reflections maybe captured when an illumination source is operated for instance as described above.

Now, as shown at 202, imaging data is generated from the captured reflections by the imaging device (110), for instance images captured by an image sensor or a camera. This imaging data portrays at least part of the vehicle (100) and is in a format suitable for analysis by the processors (130).

As shown at 203, the imaging data is acquired by the one or more processors (130) for analysis. This acquisition transmission can occur through wired or wireless connections, depending on the system's architecture.

As shown at 204, the imaging data can now be analyzed by the processors (130) to detect one or more features of one or more defects within an exterior of the vehicle (100).

When analysing the imaging data, the one or more processors (130) can identify the contour of the exterior surface of the vehicle (referred to herein as exterior) and map the one or more features of the one or more defects according to the exterior. This identification may be performed by segmenting the imaging data using a neural network trained to provide a pixel-wise segmentation label map. The one or more processors (130) can also remove light glares from the imaging data using a model of the vehicle reconstructed from the imaging data.

Optionally, defects are detected by employing by the processors (130) various algorithms and techniques to detect defects within the extracted vehicle contour. For example, the processors (130) apply edge detection algorithms, such as Canny edge detection or Sobel edge detection, to identify sharp changes in pixel intensity within the vehicle contour. These edges can represent the boundaries of potential defects, such as scratches, dents, or cracks. The processors (130) then analyse the characteristics of the detected edges, such as their length, orientation, and sharpness, to determine if they correspond to actual defects.

Additionally, or alternatively, the processors (130) apply template matching logic to compare the extracted vehicle contour with a set of predefined templates that represent common defect shapes or patterns. These templates may be created based on historical defect data or computer-generated models. The processors (130) use techniques like cross-correlation or feature matching to find areas within the vehicle contour that closely resemble the defect templates. If a strong match is found, the corresponding area is marked as a potential defect.

Additionally, or alternatively, the processors (130) apply machine learning-based classification. The processors (130) employ machine learning models, such as convolutional neural networks (CNNs), to classify different regions within the vehicle contour as defective or non-defective. These models are trained on a large dataset of labelled images, where defects are manually annotated by experts. During the detection phase, the processors (130) divide the vehicle contour into smaller patches or regions of interest (ROIs). Each patch or ROI is passed through the trained machine learning model, which assigns a probability score or label indicating the presence or absence of a defect. Patches or ROIs with high defect probability scores are considered potential defects.

Optionally the used models are trained using training data such as records consisting of image and annotation pairs, where if an image contains a defect, the coupled annotation contains the image coordinates of the defect and its label ID or class. The coordinates may be provided as an axis-aligned rectangle (bounding box), polygon vertices, a pixel map, or other methods. In another example, during the training phase, the neural network is optimized to predict the object class (“defect”) and coordinates in the image from the input image. The term “defect” can have different and more elaborate labels such as “dent,” “scratch,” “rust,” and more, but for simplicity, it is referred to as “defect” or “damage.”. In another example, classification is performed where a detection neural network provides only labels without coordinates, so the detection is performed image-wise. In this case, the neural network may be simpler. For example, when an input image contains a representation of a car door, such a neural network will only be able to determine whether there is any damage anywhere in the image, while the configuration with localization could be much more specific, positioning the defect precisely on the door handle. One way to achieve more accurate positioning in this scenario would be to divide the input image into smaller portions and perform the classification for each portion separately.

Additionally, or alternatively, the processors (130) apply anomaly detection. The processors (130) compare the extracted vehicle contour with a reference model or a set of baseline images representing a defect-free vehicle. Any significant deviations or anomalies from the reference model or baseline images are considered potential defects. Techniques like pixel-wise subtraction, statistical analysis, or unsupervised learning algorithms (e.g., autoencoders) may be used to identify these anomalies.

Additionally, or alternatively, the processors (130) apply fusion of multiple techniques. The processors (130) can combine multiple defect detection techniques to improve the overall accuracy and robustness of the system. For example, edge detection may be used to identify potential defect regions, followed by template matching or machine learning-based classification to confirm the presence of defects within those regions. The results from different techniques may be fused using weighted averaging, voting schemes, or probabilistic models to make the final defect determination.

Once the potential defects are identified, the processors (130) can further analyse their characteristics, such as size, shape, and location, to filter out false positives and refine the defect detection results.

Optionally, when vehicle positioning is not possible or chosen, an additional step is taken to reduce false alarms on background and objects by limiting the detection to a minimal image portion containing the vehicle (100). This may be implemented by training an additional object detector to detect the reflective surface (120) in the frame, crop from the full image only the portion where the reflective surface (120) is detected, and provide only this image portion as input to the defect detection system, thus reducing the probability of false alarms on the background.

Optionally, relevant image portions may be determined using image segmentation. Image segmentation is the process of assigning a label to each pixel of the image, such that pixels with the same label have a common characteristic as defined by the segmentation task. For example, for an image taken of a car over some background, the segmentation output may be defined to output “1” for every pixel containing a representation of a car and “0” for every pixel of background.

Optionally, image segmentation is achieved using a deep neural network (DNN). During training, the DNN is provided with an input image and a corresponding pixel-wise label map (targets), where the target image is in the same resolution as the input image. The DNN is optimized to predict the target image given the input image. In some embodiments, the DNN may be optimized to output a target pixel image where the pixels of the vehicle (100) will be “1” and all other pixels will be “0”.

Optionally, the defect detection is limited only to pixels containing the vehicle (100) by setting to zero all pixels of the input image where the segmentation predicted class “0” (background) or by calculating a bounding rectangle for all pixels predicted as “1” (vehicle), cropping this portion of the input image, and providing only the crop to the defect detection algorithm. Relevant pixels may be determined across frames according to motion sensing of the vehicle (100) using techniques such as odometry or simultaneous localization and mapping (SLAM). Relevant pixels may be determined across frames according to motion sensing of the vehicle (100) combined with the known 3D model of the vehicle (100).

This analysis step may be broken down into the following sub-steps:

As shown at 2041, a contour covering at least a portion of the exterior surfaces of the vehicle is extracted from the imaging data. This contour represents the outline or boundary of the vehicle's surface in the imaging data.

This allows as shown at 2042 to detect whether one or more defects are present within the contour for instance based on any of the above-described detection or classification methods. This detection may be performed using various algorithms, such as edge detection, template matching, and/or machine learning-based classification as described above.

Optionally, during the process and based on analysis of the imaging data, instructions for relocating the vehicle are presented to driver or to the controller 160 so as to guide the vehicle for completing a scanning process. For example, the guidance is to change the wheel to another direction or to drive forward or backward to acquire imaging data covering more portions of the exterior of the vehicle. For example, vehicle is driven along a support system (50) which is a physical pass-through scanning station while the processors (130) execute a code with the following steps:
1. Detecting and recognizing a scanning pattern prior to the beginning of the inspection.
2. Instruct the controller or the driver to align the vehicle (100) in terms of distance and angle with respect to the reflective surfaces (120).
3. Capture image(s) using the one or more imaging devices (110).
4. Instruct the controller or the driver to reposition the vehicle (100) according to the scan plan. Optionally, a localization may be performed and monitored during (and optionally before) the scanning by determining six degrees of freedom with respect to the position of the imaging device(s) (110) (position with respect to the vehicle (100) is known). This may be done in several well-known ways, such as determining the position of three known points on the reflective surfaces as seen from the imaging device(s) (110). In some cases, this assumption may be reduced to two points, since the imaging device(s) (110) and the vehicle (100) might be assumed to be on the same plane (e.g., a car on a road), and the rotation around the axis of the two points is considered known (e.g., the car and the system are on the plane).
5. Capture more image(s) (image number 2) using the one or more imaging devices (110).
6. Repeat 4-5 until the scan is completed.

As shown at 2043, a defect map maybe generated. The defect map indicates the spatial position of each detected defect in a model of the vehicle (100). This defect map provides a visual representation of the location and extent of the defects on the vehicle's surface.

As shown at 205, the processors (130) now output data indicative of the one or more features of the one or more defects detected in the imaging data. This output data can take various forms, such as a list of defect coordinates, a graphical overlay on the vehicle model, or a notification message.

Optionally, the output defect data may be presented to the driver of the vehicle (100) and/or used to instruct a controller (160) that manoeuvres the vehicle. The presentation to the driver may be through a display screen, a heads-up display, or an audio alert, providing them with information about the location and severity of the detected defects. Alternatively, the defect data may be fed into the controller (160) to automatically adjust the vehicle's operation, such as reducing speed, changing routes, or scheduling maintenance. By transmitting the defect detection data and analysis directly to the controller, the system may enable real-time decision-making and proactive maintenance planning. The controller can immediately incorporate the inspection findings into its functional parameters, adjusting its performance and behavior accordingly. For example, if a critical defect is detected in the vehicle's braking system, the controller can automatically limit the vehicle's speed or engage additional safety measures to mitigate potential risks until the issue is addressed.

Moreover, direct communication with the vehicle controller allows for the implementation of predictive maintenance strategies. The inspection system can continuously monitor the vehicle's condition over time, tracking the progression of wear and tear, and identifying potential failure points before they cause significant damage or downtime. By analysing this historical data and combining it with the vehicle's operational parameters, the controller can predict the remaining useful life of various components and schedule maintenance activities accordingly. This proactive approach minimizes unexpected breakdowns, optimizes resource allocation, and reduces overall maintenance costs.

The integration of the inspection system with the vehicle controller also enables a more comprehensive and context-aware inspection process. The controller can provide valuable information about the vehicle's usage patterns, environmental conditions, and performance metrics, which may be used to refine and customize the inspection algorithms. For instance, if the controller detects that the vehicle has been operating in harsh weather conditions or on challenging terrains, it can instruct the inspection system to focus on specific areas or components that are more likely to be affected by those conditions. This context-driven inspection approach enhances the accuracy and relevance of the defect detection process, ensuring that the most critical issues are identified and addressed promptly.

Furthermore, direct communication between the inspection system and the vehicle controller enhances the user experience and convenience of the inspection process. The controller can provide intuitive interfaces and interactive feedback mechanisms to present the inspection results to the vehicle operator or maintenance personnel. This can include visual displays, audible alerts, or even haptic feedback, depending on the specific implementation. By delivering the inspection findings in a user-friendly and easily interpretable format, the system empowers users to quickly understand the vehicle's condition and make informed decisions about maintenance actions.

The integration of the inspection system with the vehicle controller also facilitates remote monitoring and fleet management capabilities. The controller can transmit the inspection data and analysis to a central server or cloud-based platform, allowing fleet managers to monitor the condition of multiple vehicles simultaneously. This remote monitoring capability enables proactive maintenance planning at a fleet level, optimizing resource allocation and minimizing vehicle downtime. Fleet managers can identify common defects across the fleet, track maintenance trends, and make data-driven decisions to improve overall fleet performance and safety.

Moreover, the direct communication between the inspection system and the vehicle controller enables the implementation of automated maintenance workflows. When a defect is detected, the controller can automatically generate work orders, schedule repair tasks, and notify the appropriate maintenance personnel. This automation streamlines the maintenance process, reduces manual intervention, and ensures that defects are addressed in a timely and efficient manner. The controller can also track the progress of maintenance activities, updating the vehicle's status and maintaining a comprehensive maintenance history for future reference.

Lastly, the integration of the inspection system with the vehicle controller enhances the overall safety and compliance of the vehicle. By continuously monitoring the vehicle's condition and identifying potential safety hazards, the system helps ensure that the vehicle meets the necessary safety standards and regulations. The controller can automatically enforce safety protocols, such as limiting the vehicle's operation or triggering alerts when critical defects are detected. This real-time safety monitoring and enforcement capability reduces the risk of accidents, protects the well-being of vehicle occupants, and promotes a safer transportation ecosystem.

The one or more processors (130) may execute a code for localizing the vehicle (100) with respect to the reflective surfaces (120) and send instructions to the vehicle to align its position in terms of distance and angle with respect to the reflecting surfaces before capturing the imaging data. The code may extract the exterior by performing segmentation on the imaging data using a neural network trained to provide a pixel-wise segmentation label map indicative of the vehicle and/or parts thereof, and detect defects on a specific part of the vehicle based on the segmentation label map.

The flowchart ends with the completion of the defect data presentation or the controller instruction, and the vehicle (100) can continue its normal operation or take appropriate actions based on the inspection results.

Reference is now made to FIG. 3 which is a schematic illustration of a support system (50) for supporting auto inspection of vehicles using onboard system such as described in FIG. 1, according to some embodiments of the present invention.

The support system (50) includes one or more scaffold(s) (220) mounted along an inspection area (99). The scaffold(s) (220) serves as a framework for mounting a set of reflective surfaces (120) that reflect light towards the inspection area (99). This arrangement allows the onboard imaging device(s) on the vehicle (100) to capture reflections of the exterior of the vehicle as it passes through the inspection area (99).

Optionally, the inspection area (99) in the context of the onboard auto-inspection system is a designated area or path through which the vehicle (100) passes or park to perform the inspection process. The inspection area (99) is specifically designed and equipped with the necessary components to facilitate the capture of reflections from the vehicle's surface using the imaging devices (110) mounted on or in the vehicle.

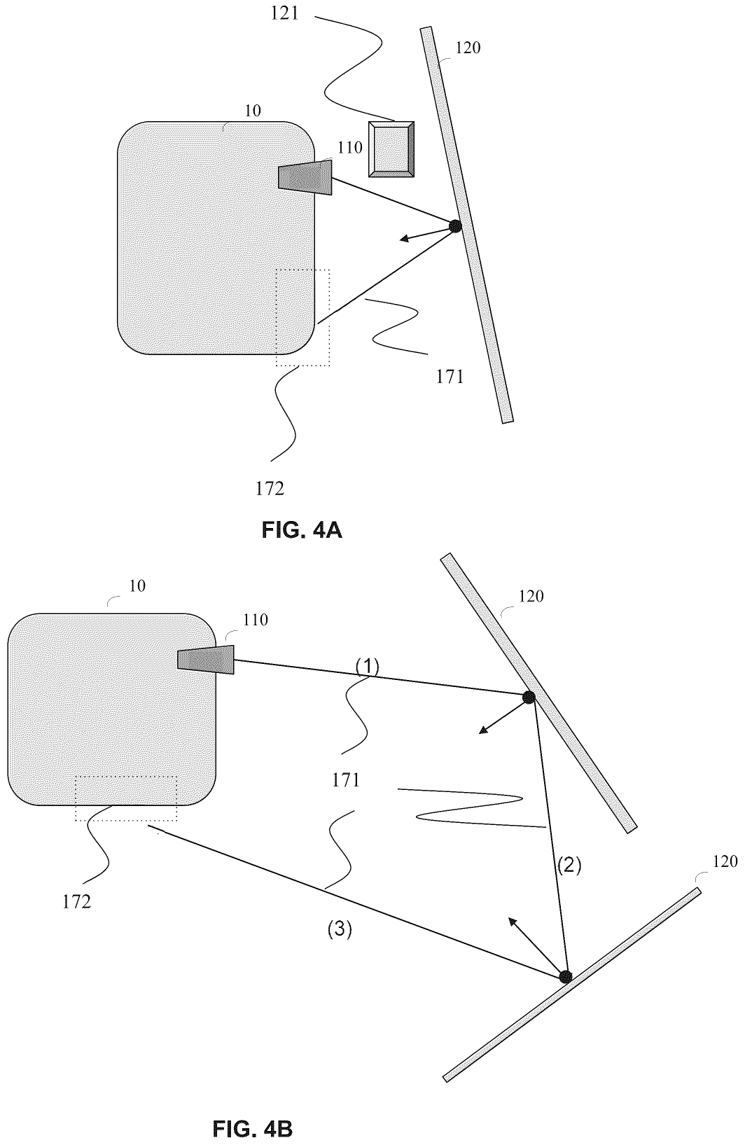

The inspection area (99) includes reflective surfaces (120), for instance lined with a plurality of reflective surfaces (120) positioned on one or more sides of a passage in the designated area. These reflective surfaces are strategically placed and oriented to reflect light from the vehicle's surface towards the imaging devices (110). The reflective surfaces may be made of various materials, such as mirrors, polished metal, or reflective coatings, depending on the desired reflectivity and durability. As shown at FIG. 4A, light reflected from one portion of the vehicle 10 is further reflected via a reflective surface 120 towards an image device 110 of the system 100 which is installed on the vehicle 10. The light may be reflected from portions which are parallel to the axis on which the image device 110 is found. As shown at FIG. 4B, light reflected from another portion of the vehicle 10 is further reflected via one reflective surface to another reflective surface 120 towards an image device 110 of the system 100 which is installed on the vehicle 10. Using multiple reflective surfaces mounted in different angles in relation to one another the image device 110 can capture images from different portions of the vehicle, for instance portions which are perpendicular to the axis on which the image device 110 is found.

Optionally, the inspection area (99) may include additional lighting sources to ensure adequate and consistent illumination of the vehicle's surface during the inspection process. The lighting may be positioned above, below, or on the sides of the passage, depending on the specific requirements of the system. The illumination should be uniform and diffuse to minimize shadows and glare that could interfere with the defect detection process.

The set of reflective surfaces (120) are strategically positioned on the scaffold (220) to reflect light towards one or more imaging devices (110) mounted on or in the vehicle (100) when the vehicle is positioned in the inspection area (99). The reflective surfaces (120) are designed to reflect light in a spectrum that is visible to the one or more imaging devices (110), ensuring that the captured reflections may be effectively processed and analysed.

The positioning of the set of reflective surfaces (120) may be based on or actively adapted using actuators (260) based on one or more system parameters, which are selected to optimize the inspection process. These parameters include the distance between the one or more imaging devices (110) and one or more of the sets of reflective surfaces (120), the distance between the vehicle (100) and one or more of the sets of reflective surfaces (120), the angle between the vehicle (100) and the one or more imaging devices (110) and the angle between the vehicle (100) and one or more of the sets of reflective surfaces (120).

Alternatively, the support system (50) is a passive system, where the vehicle system (100) performs the analysis and is equipped with the necessary imaging sensors and optionally actuators for maneuvering the imaging sensors. One of the key advantages of this approach is the ease of installation and deployment. The support system (50) may be easily integrated into a private garage or parking space without requiring extensive infrastructure modifications or complex setups. The reflective surfaces (120) may be mounted on portable or foldable structures, such as telescopic arms or collapsible frames, allowing for compact storage when not in use. This flexibility enables vehicle owners to perform regular inspections conveniently within their own premises, saving time and effort compared to visiting specialized inspection facilities. Moreover, the foldable design of the reflective surfaces makes the support system (50) is highly adaptable to different garage layouts and space constraints. To ensure accurate and reliable defect detection, the foldable device may be equipped with calibration mechanisms, such as reference markers or sensors, which allow the vehicle system (100) to determine the precise position and orientation of the reflective surfaces relative to the vehicle. This calibration process may be automated, with the vehicle system (100) capturing images of the reference markers and adjusting its analysis parameters accordingly. By combining the convenience of a passive system with the precision of onboard imaging sensors and processing capabilities, the support system (50) empowers vehicle owners to take proactive measures in maintaining the safety and integrity of their vehicles, while minimizing the need for costly and time-consuming manual inspections.

By considering these parameters, the support system (50) has reflective surfaces (120) which are positioned to capture comprehensive and detailed reflections of the vehicle's exterior from various angles.

To accommodate different types and models of vehicles, the one or more system parameters may be specifically tailored to each vehicle (100). This customization allows the support system (50) to adapt to the unique dimensions, imaging device placements, and other characteristics of each vehicle, ensuring optimal inspection performance across a wide range of vehicles.

To facilitate automatic identification and tracking of the reflective surfaces (120), at least one reflective surface may have a machine-readable code embedded within it as described above. This code may be scanned and interpreted by the vehicle's onboard imaging devices or processors to identify the specific reflective surface and associate it with predefined inspection routines or analysis parameters.

In addition to the reflective surfaces (120), the support system (50) includes a localizing device (230) configured to determine the relative position of the vehicle (100) with respect to the set of reflective surfaces (120). This localization helps ensure that the vehicle is properly aligned with the reflective surfaces during the inspection process, allowing for accurate and consistent reflection capture.

The localizing device (230) may be implemented using various technologies, such as a radio-frequency identification (RFID) reader that detects RFID tags placed on the vehicle or the scaffold, a Bluetooth receiver that communicates with Bluetooth beacons on the vehicle or the scaffold, a Wi-Fi receiver that triangulates the vehicle's position based on Wi-Fi signals and/or an imaging device that visually detects and tracks the vehicle's position relative to the reflective surfaces.

By incorporating the localizing device (230), the support system (50) can provide real-time feedback to the vehicle's control systems or the driver, ensuring proper positioning and alignment throughout the inspection process.

Optionally, sensures and/or triggers (240) are used to detect the presence and position of the vehicle (100) as it enters and moves through the passage. These sensors can include infrared detectors, pressure sensors, or magnetic loops embedded in the floor of the passage. The sensors send signals to the processors (130) to initiate the image capture and analysis process at the appropriate times.

Optionally, the inspection area (99) is designed with appropriate dimensions and layout to accommodate the size and shape of the vehicles (100) being inspected. The width of the passage allows sufficient clearance for the vehicle to pass through safely, while the height provides enough space for the imaging devices (110) to capture reflections from all relevant surfaces. The length of the passage is sufficient to allow the vehicle to capture multiple images from different angles as it moves through, ensuring comprehensive coverage of the vehicle's surface.

Alternatively, the reflective surfaces are moved using actuators along the passage.

Furthermore, the one or more processors (130) may execute a code for localizing the one or more defects on the exterior according to the imaging data and control the one or more actuators (114) accordingly. The code can also localize at least one of the plurality of reflective surfaces (120) according to the imaging data and control the one or more actuators (114) accordingly.

Optionally, the reflective surfaces (120) are positioned in such a manner that when a vehicle (100) is located at a predetermined position relative to the reflective surfaces (120), one or more imaging devices (110) onboard the vehicle (100) can capture an image reflecting a portion of the vehicle (100) through the reflective surfaces (120). Optionally, the system parameters used for determining the configuration of the reflective surfaces (120) include:
1. The distance between the one or more imaging devices (110) and the reflective surfaces (120).
2. The distance between the vehicle (100) and the reflective surfaces (120).
3. The angle between the vehicle (100) and the one or more imaging devices (110), and the angle between the vehicle (100) and the reflective surfaces (120).
4. The parameters of the one or more imaging devices (110), such as resolution, field of view, and focus.
   These parameters may vary for different vehicles (100), resulting in different precise values for different systems.

Optionally, the support system (50) is configured to allow multiple vehicles (100) to perform inspections over time, assuming that the vehicles (10) are moving with respect to the system. Optionally, the inspection process, which includes acquiring images for inspection and performing the inspection, is triggered when the vehicle (10) is positioned within the range of planned positions. This may be achieved through one or more sensors on the vehicle (10) can detect the support system (50). For example, a QR code may be placed on one of the reflective surfaces (120), and an onboard imaging device (110) can capture the QR code as the vehicle (100) moves past the support system (50), providing precise localization information with respect to the support system (50). Another option is using a sensor that is part of the support system (50) that detects the vehicle (10). For example, an overview imaging device positioned as part of the inspection system and pointed outward can obtain an image of the vehicle (100), providing precise position information. In such cases, the information will need to be provided to the inspection algorithm for positioning and triggering.

According to some embodiments of the present invention there is provided a kit that includes both the onboard auto-inspection system which is depicted in FIG. 1 and a support system with reflective surfaces such as depicted in FIG. 3. This kit provides a comprehensive solution for vehicle owners, fleet managers, and automotive service providers who wish to implement an efficient and reliable onboard auto-inspection setup.

The kit includes all the necessary components for the onboard auto-inspection system, such as the imaging devices, processors such as processing circuitries, wiring harnesses, and mounting hardware. These components are designed to be easily integrated into the vehicle's existing systems, allowing for seamless installation and operation. The kit also includes detailed installation instructions, software packages, and user manuals to guide users through the setup and configuration process.

In addition to the onboard components, the kit also includes the support system, which consists of the scaffold and the set of reflective surfaces. The scaffold may be designed to be modular and adjustable, allowing it to be adapted to various garage or parking space configurations. The reflective surfaces are carefully engineered to provide optimal reflectivity and durability, ensuring high-quality imaging data for accurate defect detection.

The kit may also include optional accessories, such as additional lighting fixtures, power supplies, and protective casings, to enhance the performance and longevity of the system. These accessories may be easily integrated into the support system or the vehicle, depending on the specific requirements of the installation site.

By providing a complete kit that includes both the onboard auto-inspection system and the support system, the present invention offers a turnkey solution for vehicle inspection and maintenance. This kit eliminates the need for users to source individual components or worry about compatibility issues, streamlining the adoption process and ensuring optimal performance from the outset.

Moreover, the kit may be customized to suit the specific needs of different users, such as fleet operators, automotive workshops, or individual vehicle owners. This customization may include tailored software packages, additional imaging devices, or specialized reflective surface configurations to accommodate unique vehicle types or inspection requirements.

It is important to note that while embodiments of the present invention are primarily described in the context of onboard auto-inspection for vehicles, the systems and methods disclosed herein can be adapted to inspect a wide range of objects beyond the automotive industry. The principles of using strategically positioned reflective surfaces, imaging devices, and advanced image processing techniques can be applied to inspect various other objects, such as electric appliances, industrial machinery, and consumer goods.

For example, the onboard inspection system can be integrated into household appliances, such as refrigerators, washing machines, or dishwashers. By incorporating imaging devices and reflective surfaces within the appliance, the system can capture and analyze imaging data to detect defects, wear and tear, or other anomalies on the appliance's exterior or interior surfaces. This can help users identify potential issues early on, schedule preventive maintenance, and extend the lifespan of their appliances.

Similarly, in industrial settings, the inspection system can be deployed to monitor the condition of manufacturing equipment, conveyor systems, or other machinery. By capturing reflections of the equipment's surfaces from various angles, the system can detect cracks, corrosion, or other structural defects that may compromise the equipment's performance or safety. This can help prevent unexpected breakdowns, optimize maintenance schedules, and improve overall operational efficiency.

Furthermore, the modular nature of the support system, with its adjustable scaffold and reflective surfaces, allows for easy adaptation to different object sizes, shapes, and inspection requirements. This flexibility enables the system to be used in a wide range of settings, from small-scale workshops to large industrial facilities.

In essence, the onboard inspection system and the associated methods described in this invention represent a versatile and powerful tool for object inspection and condition monitoring. While the primary focus of the description is on vehicles, the underlying principles and technologies can be readily applied to inspect and maintain a diverse array of objects, from consumer appliances to industrial equipment, thereby promoting safety, reliability, and efficiency across various industries.

It is expected that during the life of a patent maturing from this application many relevant devices and sensors and processors and reflective surfaces will be developed and the scope of these terms is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A vehicle system (100) for providing one or more onboard auto-inspection capabilities to a vehicle, comprising:
at least one imaging device (110) mounted on or in the vehicle for capturing reflections from a plurality of reflective surfaces (120) positioned on at least one side of the vehicle and generating therefrom imaging data portraying at least part of the vehicle;
one or more processors (130) configured for:
receiving the imaging data;
analysing the imaging data for detecting one or more features of one or more defects within a contour of the vehicle; and
outputting data indicative of the one or more features of the one or more defects.

2. The vehicle system according to claim 1, wherein the one or more features comprises spatial position data mapping the one or more defects in a model of the vehicle.

3. The vehicle system according to claim 1, wherein the model of the vehicle is reconstructed from the sequence of images.

4. The vehicle system according to claim 1, wherein the analysing is based on one or more system parameters selected from a group comprising: a distance between the at least one imaging device (110) and one or more of the plurality of reflective surfaces (120), a distance between the vehicle (100) and one or more of the plurality reflective surfaces (120), an angle between a portion of the vehicle having the one or more defects and the at least one imaging device (110), and a resolution of the at least one image, a field of view of the at least one image, and a focus parameter of the at least one image.

5. The vehicle system according to claim 1, wherein the at least one imaging device (110) comprising at least one actuator (114) adapted to tilt the at least one imaging device (110) or a part thereof according to a scanning pattern so as capture the reflections from different portions of the vehicle.

6. The vehicle system according to claim 1, wherein one or more of the plurality of reflective surfaces (120) have a machine-readable marking, wherein the analysing comprises identifying one of the plurality of reflective surfaces according to the machine-readable marking and performing the analysing according to predefined logic defined for the one of the plurality of reflective surfaces.

7. The vehicle system according to claim 1, further comprising a communication circuitry (140) adapted to receive a signal from a wireless transmitter (150); wherein the one or more processors (130) is configured for performing the analysing after the signal is received.

8. The vehicle system according to claim 1, wherein the one or more processors (130) is further configured for determining relative spatial location of the vehicle in relation to at least one of the plurality of reflective surfaces (120) and performing the analysing according to the relative spatial location.

9. The vehicle system according to claim 1, wherein the one or more processors (130) is further configured for
determining relative spatial location of the vehicle in relation to at least one of the pluralities of reflective surfaces (120),
calculating driving instructions for manoeuvring the vehicle according to the relative spatial location, and
outputting the driving instructions for presentation to a driver.

10. The vehicle system according to claim 1, wherein the one or more processors (130) is further configured for:
determining relative spatial location of the vehicle in relation to at least one of the pluralities of reflective surfaces (120),
calculating driving instructions for manoeuvring the vehicle according to the relative spatial location, and
outputting the driving instructions for presentation to a controller (160) configured for manoeuvring the vehicle accordingly.

11. The vehicle system according to claim 1, wherein the at least one imaging device (110) and the one or more processors (130) are integrated in the vehicle.

12. The vehicle system according to claim 1, wherein the analysing comprises at least one of:
identifying the contour of the vehicle and mapping the one or more features of one or more defects according to the contour; and
removing light glares from the imaging data using a model of the vehicle reconstructed from the imaging data.

13. The vehicle system according to claim 1, wherein the one or more processors (130) is further configured for localizing the vehicle (100) with respect to the reflective surfaces (120) and sending instructions to the vehicle to align its position in terms of distance and angle with respect to the reflecting surfaces, prior to capturing the imaging data.

14. The vehicle system according to claim 1, wherein the one or more processors (130) is configured to extract the contour by performing segmentation on the imaging data using a neural network trained to provide a pixel-wise segmentation label map indicative of
at least one of the vehicle and/parts of the vehicle, wherein the one or more processors (130)
is configured to detect defects on a specific part of the vehicle based on the segmentation.

15. The vehicle system according to claim 6, wherein the one or more processors (130) are configured for localizing at least one of:
the one or more defects on the contour, and
at least one of the plurality of reflective surfaces (120)
according to the imaging data and controlling the at least one actuator (114) accordingly.

16. A method for performing an onboard auto-inspection of a vehicle (100), comprising: using at least one imaging device (110) mounted on or in the vehicle for capturing reflections from a plurality of reflective surfaces (120) positioned on at least one side of the vehicle; generating from the reflections imaging data portraying at least part of the vehicle; using one or more processors (130) for analysing the imaging data for detecting one or more features of one or more defects within a contour of the vehicle; and outputting data indicative of the one or more features of the one or more defects for presentation to a driver of the vehicle or for instructing a controller (160) manoeuvring the vehicle.

17. The method of claim 16, wherein the analysing comprises: extracting a contour of at least a portion of the vehicle from the imaging data; detecting whether one or more defects are present within the contour; and generating a defect map indicative of a spatial position of each of the one or more defects in a model of the vehicle.

18. A system to support onboard auto-inspection of a vehicle (100), comprising:
a scaffold (220) mounted along an inspection passage; and
a set of reflective surfaces (120) mounted on the scaffold to reflect light towards the inspection passage;
wherein the set of reflective surfaces (120) are positioned to reflect light towards at least one imaging device (110) mounted on or in the vehicle (100) when the vehicle is positioned in the inspection passage.

19. The system according to claim 18, wherein the set of reflective surfaces (120) are configured to reflect light in a spectrum visible to the at least one imaging device (110).

20. The system according to claim 18, wherein the set of reflective surfaces (120) are positioned based on one or more system parameters selected from a group comprising: a distance between the at least one imaging device (110) and one or more of the set of reflective surfaces (120), a distance between the vehicle (100) and one or more of the set of reflective surfaces (120), an angle between the vehicle (100) and the at least one imaging device (110), and an angle between the vehicle (100) and one or more of the set of reflective surfaces (120).

21. The system according to claim 18, wherein the one or more system parameters are specific to a type and/or model of the vehicle (100).

22. The system according to claim 18, wherein at least one reflective surface of the set of reflective surfaces (120) has a machine-readable code embedded therein.

23. The system according to claim 18, further comprising a localizing device (230) configured to determine a relative position of the vehicle (100) with respect to the set of reflective surfaces (120), wherein the localizing device (230) comprises at least one of: a radio-frequency identification (RFID) reader, a Bluetooth receiver, a Wi-Fi receiver, and an imaging device.

24. A non-transitory computer-readable medium storing instructions that, when executed by one or more processors (130), cause the one or more processors to perform the method according to claim 16.
